(19) United States
(12) Patent Application Publication
(10) Pub. No.: US 2026/0296379 A1
(43) Pub. Date: Oct. 1, 2026

(54) CLEANING DEVICE FOR RIMS

(71) Applicant: Edgar Chapman, Genoa, IL (US)

(72) Inventor: Edgar Chapman, Genoa, IL (US)

(21) Appl. No.: 19/664,573

(22) Filed: Apr. 30, 2026

Related U.S. Application Data
(63) Continuation-in-part of application No. 19/037,619, filed on Jan. 27, 2025.
(60) Provisional application No. 63/632,310, filed on Apr. 10, 2024.

(51) Int. Cl. B60S 3/04; B08B 1/14; B08B 1/30; B25G 1/04

(52) U.S. Cl. CPC B60S 3/042; B08B 1/14; B08B 1/30; B25G 1/04

(57) ABSTRACT

A cleaning device for cleaning barrels of rims. The cleaning device includes a curved blade having an inner side and an outer side; a rod hingedly coupled to the inner side of the curved blade; and a cleaning pad coupled to the outer side of the curved blade. The rod can pivot transversely to the longitudinal axis of the curved blade, the longitudinal axis is along a length of the curved blade.

### CROSS-REFERENCE TO RELATED APPLICATIONS

This application is continuation-in-part of a s U.S. patent application Ser. No. 19/037,619, filed on Jan. 27, 2025, which claims priority from a U.S. Provisional Patent Appl. No. 63/632,310, filed on Apr. 10, 2024, both of which are incorporated herein by reference in its entirety.

### FIELD OF INVENTION

The present invention relates generally to cleaning tools for automotive components. More particularly, the present invention is directed to a device specifically configured for cleaning the inner barrel of an automobile wheel rim.

### BACKGROUND

Maintaining the cleanliness and appearance of automobiles is an important concern for many vehicle owners. A variety of tools and accessories exist to clean exterior vehicle surfaces; however, certain components present unique challenges. Wheel rims, in particular, include tight and recessed regions that are difficult to access, especially the barrel portion located behind the spokes. Conventional cleaning methods require users to insert their hands into narrow spaces, which can result in inadequate cleaning, discomfort, and potential injury. Despite the importance of maintaining a clean and polished barrel surface for aesthetic and maintenance reasons, existing tools often fail to reach and effectively clean this area.

Accordingly, there exists a need for an improved cleaning device that facilitates safe, efficient, and thorough cleaning of the barrel portion of a wheel rim.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

It is a principal object of the present invention to provide a cleaning device specifically configured for cleaning the barrel portion of an automobile wheel rim.

It is another object of the present invention to provide a cleaning device that can conveniently access the barrel area through the narrow spaces between the rim spokes.

It is a further object of the present invention to provide a cleaning device capable of effectively removing dirt, brake dust, and contaminants from the barrel.

It is yet another object of the present invention to provide a cleaning device that is simple and comfortable to use.

It is still another object of the present invention to provide a cleaning device that is durable, cost-effective, and economical to manufacture.

The present invention provides a cleaning device specifically configured for cleaning the barrel of an automobile wheel rim. The device enables effective access to hard-to-reach interior rim surfaces through narrow spaces between rim spokes, while improving cleaning efficiency and user safety.

In one aspect, disclosed is a cleaning device for rims, the cleaning device comprises a curved blade having an inner side and an outer side; a rod hingedly coupled to the inner side of the curved blade, wherein the rod is configured to pivot transversely to a longitudinal axis of the curved blade, the longitudinal axis is along a length of the curved blade; and a cleaning pad configured to interchangeably coupled to the outer side of the curved blade. The cleaning device further comprises a hinge connector of a T-shape, wherein the rod is coupled to the curved blade through the hinge connector. The cleaning device further comprises an extension rod configured to couple to the rod to increase the effective length of the rod. The cleaning device comprises a bracket coupled to the inner side of the curved blade, wherein the hinge connector is coupled to the bracket.

In one aspect, disclosed is a method for cleaning barrels of a rim, the method comprises providing a cleaning device. The cleaning device comprises a curved blade having an inner side and an outer side; a rod hingedly coupled to the inner side of the curved blade, wherein the rod is configured to pivot transversely to a longitudinal axis of the curved blade, the longitudinal axis is along a length of the curved blade; and a cleaning pad configured to interchangeably be coupled to the outer side of the curved blade. The method further comprises inserting the curved blade through spokes of the rim, and placing it over a barrel of the rim; and moving the curved blade left and right over the barrel.

In one aspect, the cleaning device includes a curved blade configured to substantially conform to the curvature of the rim barrel to maximize surface contact during cleaning. A pair of brackets is positioned on an inner side of the curved blade, and a hinge connector is coupled to the brackets to permit transverse rotation of the curved blade relative to the handle. A pair of removable clips is engaged with the brackets to retain the hinge connector under operating stress.

A rod extends from the hinge connector to allow manipulation of the curved blade from outside the rim structure. A removable cleaning pad is configured for attachment to an outer side of the curved blade, enabling interchangeable cleaning, polishing, drying, or dusting functions depending on the selected pad.

The disclosed cleaning device improves reachability, provides a larger contact area for more efficient cleaning of the barrel, reduces the risk of injury to the user's hands, and is simple to operate. The device is adaptable to different rim sizes and may incorporate interchangeable rods or cleaning pads to enhance versatility.

Accordingly, the present invention overcomes limitations of conventional automotive cleaning tools by enabling thorough cleaning of otherwise inaccessible portions of the wheel rim barrel while maintaining ease of use and manufacturing efficiency.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 illustrates a perspective view of a cleaning device, according to an exemplary embodiment of the present invention.

FIG. 2 illustrates another perspective view of the cleaning device, according to an exemplary embodiment of the present invention.

FIG. 3 illustrates an exploded view of the cleaning device, according to an exemplary embodiment of the present invention.

FIG. 4 illustrates a hinge connector of the cleaning device, according to an exemplary embodiment of the present invention.

FIG. 5 illustrates a curved blade of the cleaning device, according to an exemplary embodiment of the present invention.

FIG. 6 illustrates an exploded view of the cleaning device including clips, according to an exemplary embodiment of the present invention.

FIG. 7 illustrates an assembled view of the cleaning device including clips, according to an exemplary embodiment of the present invention.

FIG. 8 illustrates a spring attachment mechanism of the cleaning device, according to an exemplary embodiment of the present invention.

FIG. 9 illustrates a perspective view of the cleaning device including clips, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the allowed claims of any resulting patent will best define the scope of the invention.

Disclosed herein is a cleaning device for cleaning the barrel portion of wheel rims of automobiles, such as cars. The cleaning device enables easier and more efficient cleaning of the barrel, resulting in a tidy and polished barrel surface. The cleaning head of the device can be conveniently inserted through the narrow spaces between rim spokes. Additionally, the cleaning head provides a relatively large surface area for contact with the rim barrel, facilitating more efficient and quicker cleaning.

The cleaning head includes a curved flat surface configured to achieve substantially full surface contact with the barrel, thereby enhancing cleaning performance. The device also allows access to regions between components like brake caliper, emergency brake caliper, control arms and the interior of the wheel barrel. In some implementations, the device can clean approximately 30% of the inside barrel when positioned between only two spokes. The device thereby facilitates complete cleaning of areas traditionally difficult to reach using conventional cleaning tools. A variety of cleaning pads may be attached to the cleaning head, providing versatility for different operations such as cleaning, drying, dusting, or surface protection.

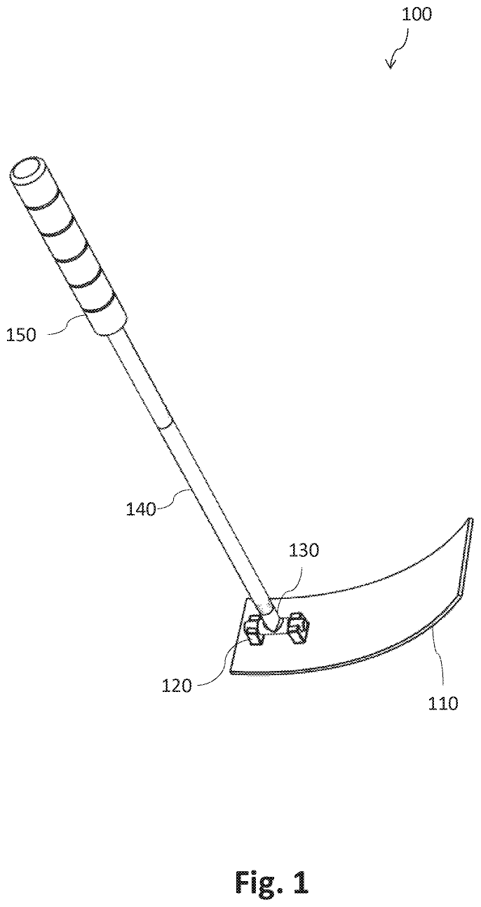

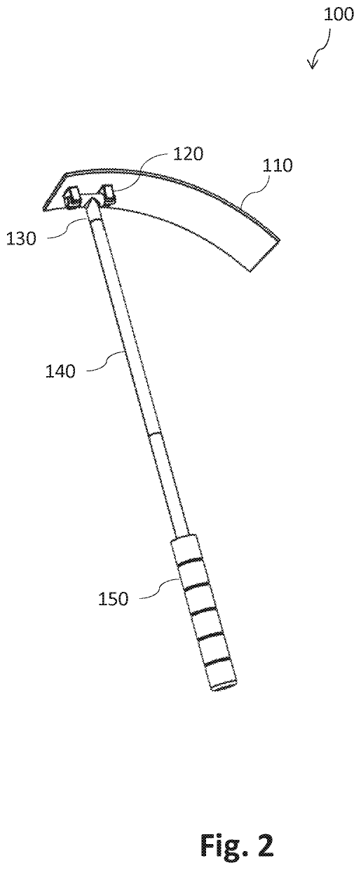

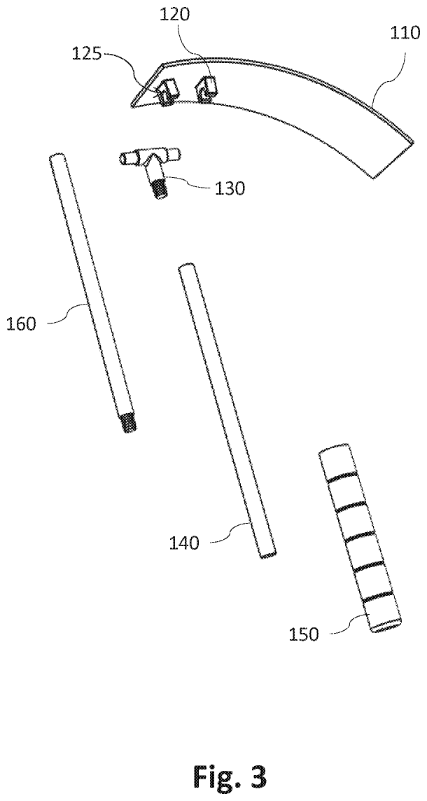

Reference is now made to FIGS. 1-3, which illustrate different aspects of a cleaning device 100 according to one exemplary embodiment of the invention. The cleaning device 100 includes a curved blade 110, a pair of brackets 120 integral with or secured to the curved blade 110, a hinge connector 130 configured to hingedly couple to the pair of brackets 120, a rod 140 coupled to the hinge connector 130, and a handle 150 coupled to an end of the rod 140.

The curvature of the curved blade 110 substantially corresponds to the diameter of a wheel rim to achieve optimal surface conformity. The curved blade 110 may be adapted for use with rims of various sizes, including but not limited to 18-inch, 20-inch, and 22-inch rims. The curved blade 110 may be formed from a flexible material to allow slight deformation under pressure, enabling conformity to various rim geometries.

In certain implementations, the curved blade 110 may have a width of approximately 2.5 inches and a flat surface segment of approximately 10-14 inches in length. These dimensions may vary without departing from the scope of the invention, and may be selected based on the geometry of the target wheel rim. The blade 110 may be constructed from a flexible plastic material, although any suitable alternative material remains within the scope of the present invention.

A pair of spaced-apart brackets 120 may be positioned on the inner side of the curved blade 110. The brackets 120 may be attached using an adhesive or formed integrally with the blade 110. Each bracket 120 includes a receiving member 125, such as a clamp, configured to snap-fit a tubular portion of the hinge connector 130. Opposing walls of the receiving member 125 may flex outwardly to receive the tubular portion and then return to their original position to secure it. The tubular portion may rotate relative to the receiving member 125, thereby allowing pivotal motion of the cleaning head. Other fastening or hinging mechanisms may also be employed without departing from the scope of the invention.

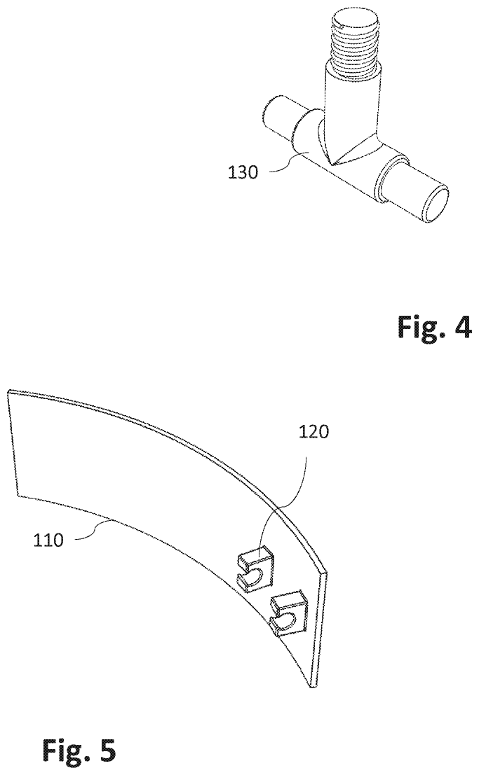

The hinge connector 130, shown more clearly in FIG. 4, may be generally T-shaped and include a tubular mounting member configured to snap-fit into the brackets 120 for transverse rotation relative to the curved blade 110. The hinge connector 130 may support rotation of approximately 180 degrees to either side of the blade 110. A vertical leg of the hinge connector 130 may be coupled to the rod 140 via a joint, enabling adjustment of the cleaning angle. The rod 140 may include, at its opposite end, a handle 150 for gripping the device. In some embodiments, one or more extension rods 160 may be selectively added to adjust the overall length of the rod 140.

The device may further include detachable cleaning pads configured to be fitted over the curved blade 110. Different pads may be interchangeably selected for cleaning, drying, dusting, polishing, or other functions. Each pad may include pockets, edge sleeves, or peripheral seams for receiving the blade 110. Attachment may be achieved using any suitable fastening mechanism, including adhesives, hook-and-loop fasteners, snap-fit buttons, or other mechanical arrangements, all of which remain within the scope of the invention.

In operation, a user may secure a desired cleaning pad onto the curved blade 110 and insert the cleaning head through the rim spokes to position it against the barrel surface. The handle may then be rotated downward, and the cleaning head moved laterally along the barrel surface. In some implementations, the device may enable cleaning of approximately 30% of the rim barrel when the handle is positioned between two spokes. The rod length may be adjustable between approximately 12-20 inches to enable cleaning from the front edge of the wheel to the back portion of the barrel, including deeper areas of wide rims.

In certain implementations, the arc length and curvature of the blade 110 may be selected based on the barrel radius of specific rim sizes. For example: For an 18-inch wheel with an inner circumference of approximately 53.4 inches and a barrel radius of approximately 8.5 inches, the blade may have an arc length of approximately 11 inches, a curvature angle of approximately 74.1°, and a width of approximately 2.5 inches; for a 20-inch wheel with an inner circumference of approximately 59.7 inches and a barrel radius of approximately 9.5 inches, the blade may have an arc length of approximately 12 inches, a curvature angle of approximately 72.4°, and a width of approximately 2.5 inches; and for a 22-inch wheel with an inner circumference of approximately 66.0 inches and a barrel radius of approximately 10.5 inches, the blade may have an arc length of approximately 13 inches, a curvature angle of approximately 70.9°, and a width of approximately 2.5 inches. These parameters may vary without departing from the scope of the invention.

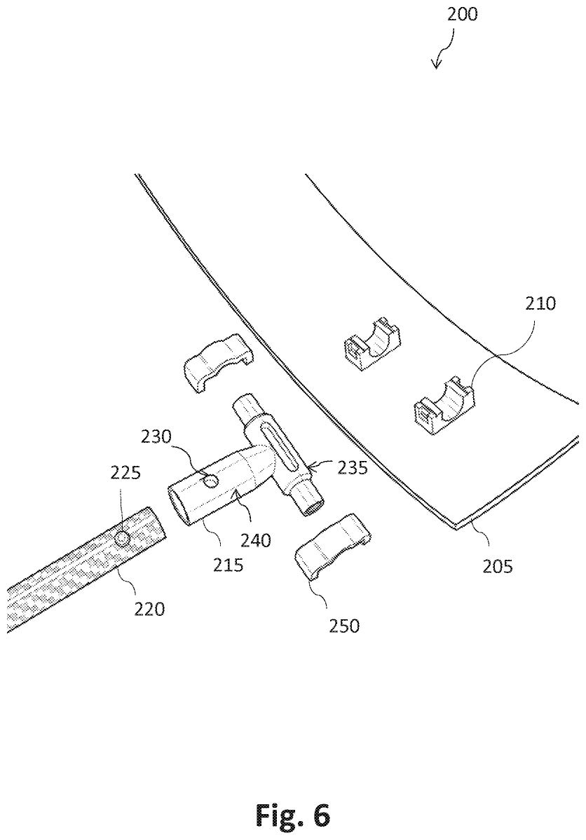

Referring to FIG. 6, another exemplary mechanism for securing the hinge connector to the brackets is illustrated. In this embodiment, a cleaning device 200 includes a curved blade 205, a pair of brackets 210 formed with or coupled to the curved blade 205, a hinge connector 215 configured to hingedly couple to the pair of brackets 210, and a rod 220 coupled to the hinge connector 215. The rod 220 includes a hole 225 near an end thereof for securing the rod 220 to the hinge connector 215. The hinge connector 215 may also include a corresponding hole 230. FIG. 6 further shows a spring clip positioned within the rod 220, such that a button portion of the spring clip protrudes through the hole 225 to engage the hole 230 of the hinge connector 215.

The hinge connector 215 is generally T-shaped and includes a tubular mounting member 235 configured to be received within the brackets 210, permitting transverse rotation relative to the curved blade 205. The hinge connector 215 may support rotation of approximately 180 degrees to either side of the curved blade 205. The cleaning device 200 further includes clips 250 that may be attached to the brackets 210 to retain the tubular mounting member 235. During operation, rotational stress may be applied to the hinge connector 215; therefore, the clips 250 help maintain secure engagement between the hinge connector 215 and the brackets 210.

A vertical leg 240 of the hinge connector 215 may be coupled to the rod 220 through a joint, thereby enabling adjustment of the cleaning angle. As shown in FIG. 6, the vertical leg 240 may include a sleeve configured to receive the end portion of the rod 220. The aligned holes 225 and 230 in the rod 220 and the vertical leg 240 allow a fastener to secure the rod 220 to the hinge connector 21.

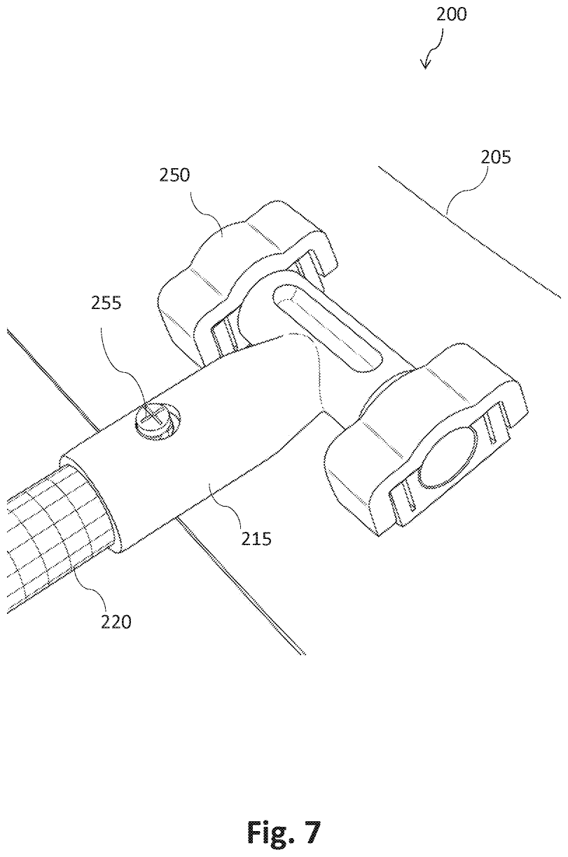

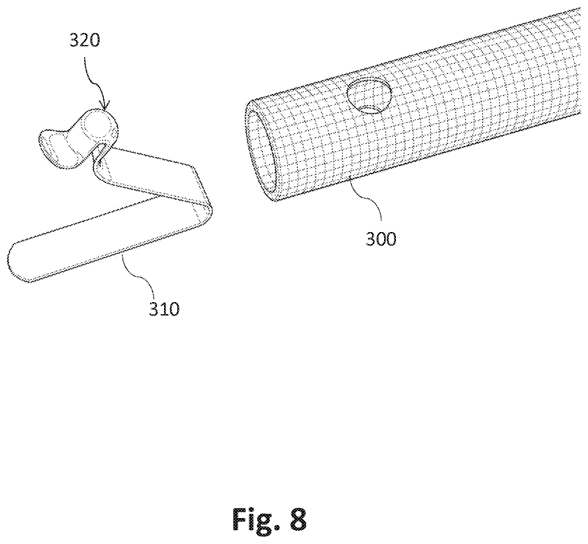

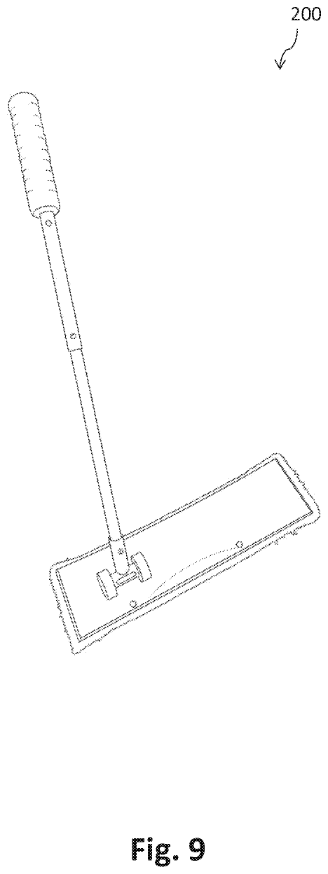

As shown in FIG. 7, the fastener may be a screw 255 configured to secure the rod 220 to the hinge connector 215. However, different fasteners may be used without departing from the scope of the invention. For example, FIG. 8 illustrates an embodiment employing a spring clip 310 inserted into the rod 300, wherein a button portion 320 of the spring clip 310 protrudes through an opening in the rod 300. A similar spring-clip-based fastening mechanism may also be used to connect one or more extension rods to the primary rod.

As shown in FIG. 1, the hinge joint formed by the bracket 120 and the hinge connector 130 is positioned offset relative to a centerline of the curved blade 110. The offset arrangement of the rod and handle relative to the curved blade 110 provides several advantages. In particular, the offset configuration allows a greater effective cleaning surface area while maintaining access to confined and hard-to-reach regions of the wheel rim barrel. Additionally, the handle may be rotated or flipped through approximately 180 degrees to present an opposite cleaning orientation. As a result, the cleaning device can effectively clean in multiple directions, and the offset configuration increases effective cleaning coverage without increasing the physical width of the curved blade 110. Although the offset configuration may be preferred in certain embodiments, the position of the hinge joint relative to the curved blade 110 may be varied, including a centered or alternative offset position, without departing from the scope of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A cleaning device for cleaning a barrel of a wheel rim of an automobile, comprising:
curved blade configured to conform to a curvature of the barrel of the wheel rim, the curved blade having an inner side and an outer side;
a pair of brackets disposed on the inner side of the curved blade;
a pair of clips configured to be removably coupled to the pair of brackets, respectively;
a hinge connector including a tubular mounting member, the tubular mounting member being hingedly coupled to the pair of brackets to allow transverse rotation of the curved blade relative to the hinge connector, and being retained on the pair of brackets using the pair of clips;
a rod coupled to the hinge connector; and
a cleaning pad configured to be interchangeably attached to the outer side of the curved blade.

2. The cleaning device of claim 2, wherein the cleaning device further comprises:
an extension rod configured to couple to the rod for increasing an effective length of the rod.

3. The cleaning device of claim 1, wherein the rod is configured to rotate about 180 degrees relative to the curved blade.

4. The cleaning device of claim 1, wherein the hinge connector comprises a T-shaped body having a vertical leg, and the rod is coupled to the vertical leg.

5. The cleaning device of claim 4, wherein the vertical leg includes a sleeve configured to receive an end portion of the rod.

6. The cleaning device of claim 5, wherein the rod and the vertical leg include aligned holes configured to receive a fastener for securing the rod to the hinge connector.

7. The cleaning device of claim 6, wherein the fastener comprises a spring clip retained within the rod and having a button portion projecting through the aligned holes.

8. The cleaning device of claim 1, wherein the curved blade has an arc length and curvature angle selected based on a barrel radius of the wheel rim.

9. The cleaning device of claim 3 wherein the pair of brackets are positioned offset relative to the curved blade to enable bidirectional cleaning operation of the curved blade upon rotation of the rod.

10. A method for cleaning a barrel of a wheel rim of an automobile, the method comprising:
providing a cleaning device comprising:
a curved blade configured to conform to a curvature of the barrel of the wheel rim, the curved blade having an inner side and an outer side;
a pair of brackets disposed on the inner side of the curved blade;
a pair of clips configured to be removably coupled to the pair of brackets, respectively;
a hinge connector including a tubular mounting member, the tubular mounting member being hingedly coupled to the pair of brackets to allow transverse rotation of the curved blade relative to the hinge connector, and being retained on the pair of brackets using the pair of clips;
a rod coupled to the hinge connector; and
a cleaning pad configured to be interchangeably attached to the outer side of the curved blade;
inserting the curved blade through a space between adjacent spokes of the wheel rim to position the curved blade in contact with the barrel; and
moving the curved blade along the barrel to remove dirt or debris therefrom.

11. The method of claim 10, further comprising attaching the cleaning pad to the curved blade prior to inserting the curved blade through the space between the spokes.

12. The method of claim 10, wherein moving the curved blade comprises moving the curved blade laterally along the barrel while the rod remains positioned between two of the spokes.

13. The method of claim 10, further comprising securing the rod to the hinge connector using a spring clip.

14. The method for claim 10, wherein the pair of brackets are positioned offset relative to the curved blade, the method further comprises:
flipping the rod in opposite direction; and
upon rotation of the rod, moving the curved blade along the barrel.
